(19) United States
(12) Patent Application Publication
(10) Pub. No.: US 2014/0265607 A1
(43) Pub. Date: Sep. 18, 2014

(54) System And Method For Loop-Based Direct Current Electrical Power Transmission System

(71) Applicant: Mark Peting, Yamhill, OR (US)

(72) Inventor: Mark Peting, Yamhill, OR (US)

(73) Assignee: Neofocal Systems, Inc., Portland, OR (US)

(21) Appl. No.: 13/844,557

(22) Filed: Mar. 15, 2013

(51) Int. Cl. H02J 1/00

(52) U.S. Cl. CPC H02J 1/00
USPC 307/82

(57) ABSTRACT

Electrical power is traditionally transmitted with high-voltage alternating current transmission lines. For some limited applications, high-voltage direct current is used to transmit electrical power since direct current transmission is much more efficient. However, due to the high costs of high-voltage alternating to high-voltage direct current conversion equipment, direct current transmission is rarely use. To provide direct current electrical transmission at a reduced cost, a loop-based direct current transmission system is disclosed. The loop-based direct current system operates by carrying direct current in a loop that coupled individual power consumer and power generating nodes. Each node can add voltage to or subtract voltage from the current loop.

### TECHNICAL FIELD

The present invention relates to the field of electrical power transmission systems. In particular, but not by way of limitation, the present invention discloses techniques for efficiently transmitting and distributing electrical power using direct current.

### BACKGROUND

Throughout the world, electrical power is traditionally distributed with high voltage alternating current (AC). High Voltage is used because the loss of energy during transmission is proportional to the amount of electrical current squared. Thus, raising the voltage instead of raising the current allows more energy to be transmitted without increasing the transmission losses. Alternating current (AC) was selected instead of direct current (DC) since it was much easier to transform between different voltage levels with alternating current than with direct current.

Although alternating current is used for most electrical energy transmission, alternating current has its own set of problems. Alternating current generally requires more conductors to carry electrical than direct current. Alternating current can suffer a ‘skin effect’ wherein much of the power transmission is carried by the outer surface of the conductor instead of being uniformly carried by the conductor thus resulting in transmission losses. Furthermore, it can be very difficult to transmit electrical power with alternating current with undersea or underground cables due to the increased cable capacitance. Thus, for many long-distance electrical energy transmission tasks, high-voltage direct current is used instead of alternating current.

High-Voltage direct current transmission lines can carry electrical energy over long distances with minimal transmission losses. For example, high-voltage direct current transmission line losses are typically 30 to 40% lower than alternating current transmission line losses at the same voltage levels. Alternating current transmission lines are limited by their peak voltage levels but do not transmit much power at those peak levels whereas direct current can transmit full power at the peak voltage level. Furthermore, since direct current does not involve multiple phases nor suffers from the skin effect, direct current transmission lines can have fewer conductor lines and smaller conductor lines.

However, high-voltage direct current transmission is generally avoided unless the power is being transmitted by an undersea cable or over a very long distance. High-voltage direct current is generally avoided because the conversion equipment is very complex and rare such that the conversion equipment tends to be very expensive. Thus, even though direct current provides significant efficiency advantages for electrical energy transmission, direct current is rarely used for electricity transmission. It would therefore be desirable to improve direct current electricity transmission technology such that this efficient method of electricity transmission is used more often.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1A illustrates a block diagram of a set of electrical power generation and electrical power consumption sites.

FIG. 1B illustrates the set of electrical power generation and electrical power consumption sites of FIG. 1A coupled with a traditional high-voltage AC power transmission system.

FIG. 1C illustrates the set of electrical power generation and electrical power consumption sites of FIG. 1A coupled with a direct current loop power transmission system.

FIG. 1D illustrates the direct current electrical power transmission network of FIG. 1C wherein town has added their own local wind turbine farm.

FIG. 1E illustrates an embodiment wherein there are two different direct current loops, a clockwise direct current loop and a counter-clockwise direct current loop.

FIG. 2 illustrates a block diagram of one embodiment of a bi-directional power node for a loop-based direct current electrical power transmission system.

FIG. 3 illustrates a second embodiment of a bi-directional power node for a loop-based direct current electrical power transmission system.

### DETAILED DESCRIPTION

The following detailed description includes references to the accompanying drawings, which form a part of the detailed description. The drawings show illustrations in accordance with example embodiments. These embodiments, which are also referred to herein as “examples,” are described in enough detail to enable those skilled in the art to practice the invention. It will be apparent to one skilled in the art that specific details in the example embodiments are not required in order to practice the present invention. For example, although the example embodiments are mainly disclosed with reference to renewable power generation systems, the teachings of this disclosure can be used to transmit electrical power with any type of power generation system. The example embodiments may be combined, other embodiments may be utilized, or structural, logical and electrical changes may be made without departing from the scope what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

AC Electrical Power Distribution

FIG. 1A illustrates a block diagram representation of several electrical power consumption sites and several electrical power generation sites. Towns 111, 112, and 113 all consume electrical power and have local alternating current (AC) power distribution systems. To provide electrical power to the power consumption sites 111, 112, and 113, a set of electrical power generation sites 121 to 125 are also illustrated.

The electrical power generation sites may use many different types of electrical power generation equipment. In order to reduce greenhouse gases, reduce fuel costs, and reduce pollution, various green energy sources may be desirable. In the example of FIG. 1A, two wind turbine generator farms 121 and 122 located in geographically remote windy areas are illustrated. In addition, two solar photovoltaic farms 124 and 125 located in southern sunny areas are illustrated. These green energy sources will generate variable amounts of power depending on the current weather conditions. A traditional electrical power generation plant 123 is also illustrated.

To provide the electrical power generated by the electrical power generation sites to the electrical power consumption sites an electrical power transmission system is obviously needed. Electrical power transmission is traditional performed using a high-voltage alternating current power transmission and distribution system. Typically a three-phase high-voltage alternating current power transmission and distribution system is used.

FIG. 1B illustrates a simplified diagram of the electrical power consumption sites (Towns 111 to 113) and electrical power generation sites (generation sites 121 to 125) coupled together with a three-phase high-voltage alternating current power transmission and distribution system. With a three-phase high-voltage alternating current power transmission system, the voltage level is typically held constant and then electrical generators add current to the transmission system while consumers draw current from the electrical power transmission system.

Electrical power has long been distributed using a high-voltage alternating current power transmission system because the loss of energy is minimized with high-voltage levels and it is relatively easy to transform between different voltage levels when alternating current is used instead of direct current. However, such high-voltage alternating current power transmission systems have a few undesirable characteristics.

As illustrated in FIG. 1B, the three-phase high-voltage alternating current power transmission system requires three different conductors to be coupled to every site to carry the three-phase alternating current electrical power. Furthermore, due to the skin effect of alternating current transmission, the individual conductors must be very large to carry a significant amount of current. The capacitance on transmissions lines also hinders the transmission of alternating current. The capacitance effect can be made worse when a transmission line is underground or much worse when a transmission line is placed under water.

The fact that three-phase high-voltage alternating current power transmission systems require three heavy conductors makes such three-phase high-voltage alternating current power transmission systems very expensive to deploy. Thus, although there are many remote sites that are ideal for renewable power generation sites, the renewable power generation sites are not built because of the cost and difficulty of building transmissions lines to carry the electrical power to sites such as cities where the power will be consumed.

DC Electrical Power Distribution

To avoid the disadvantages of using a high-voltage alternating current electrical power transmission system, a direct current based electrical power transmission system may be used. With a direct current electrical power transmission system, the voltage on the transmission system is typically held constant while power generators add current to the transmission system and power consumers draw current from the transmission system

A direct current electrical power distribution system generally has fewer conductors (typically two). Furthermore, a direct current electrical power distribution system may use smaller conductor wires since direct current transmission does not suffer from the skin effect. The power delivered in an alternating current system is defined by the root mean square (RMS) of the alternating current voltage, but the RMS voltage is only about 71% of the peak voltage. Therefore, if a direct current transmission system can operate continuously at the same voltage level as the peak voltage of an alternating current transmission line, then for an equal current, the power transmission capability of the direct current system when operating with HVDC is approximately 140% of the capability when operating with alternating current. Furthermore, the capacitive effect that reduces alternating current transmission efficiency does not significantly affect direct current transmission. The problem with the capacitive effect is especially true for undersea electrical power transmission.

Despite having these several advantages, direct current electrical power transmission systems are currently very rarely used in practice. The principle reason that direct current electrical power transmission systems are rarely used is that the conversion equipment to convert from the conventional high-voltage alternating current systems to high-voltage direct current is very expensive. For example, the conversion equipment for a 1 million volt system may require many semiconductor stacks that can handle 1 million volts. Such semiconductor stacks are very expensive. Furthermore, this conversion equipment is generally required at both ends of a direct current transmission line. Thus, unless a particular electrical power transmission project involves electrical power transmitted by an undersea cable or electrical power transmitted over a very long distance such that minimizing transmissions becomes very important, the very high costs of the alternating current to direct current conversion equipment generally prevent the usage of high-voltage direct current electrical power transmission.

Single Conductor Less Expensive DC Electrical Power Distribution

As set forth in the preceding section, the principle reason why direct current electrical power transmission systems are rarely used is that the conversion equipment to convert from high-voltage alternating current to direct current is very expensive. Thus despite the clear advantages of using direct current electrical power transmission, such direct current electrical power transmission systems are only used in certain specific situations. To take advantage of direct current electrical power transmission, the present document discloses a loop-based direct current electrical power transmission. The loop-based direct current electrical power transmission operates in a different manner than traditional high-voltage direct current electrical transmission systems.

The loop-based direct current electrical power transmission of the present disclosure operates by connecting together several electrical power consumption sites and several electrical power generation sites with a direct current loop network. For example, FIG. 1C illustrates the electrical power consumption sites and electrical power generation sites of FIG. 1A coupled together with a loop-based direct current electrical power transmission system that carries a loop current 150.

The loop-based direct current electrical power transmission system of FIG. 1C may use different transmission lines than the three-phase high-voltage alternating current power transmission system of FIG. 1B. First of all, only a single conductor is needed to couple two different nodes on the direct current electrical power transmission network of FIG. 1C. This simplifies the transmission lines required to connect different nodes on the loop-based direct current transmission network. And since direct current that is not significantly hindered by capacitive effects is being carried by transmission network of FIG. 1C, it will be much easier to run the transmission lines underground or underwater.

As illustrated in FIG. 1C, each electrical power consumption site and each electrical power generation site is coupled to a direct current loop network with a local power node. The direct current loop network carries a nominally constant loop current 150 through all the local power nodes coupled to the direct current loop network. Each individual site coupled to the direct current loop network with a local power node either increases the voltage potential on the direct current loop (electrical power generation sites) or decreases the voltage potential on the direct current loop (electrical power consumption sites).

For example, wind turbine generator farm 121 is coupled to bi-directional local power node 126 that is part of the loop-based direct current electrical power transmission system. The wind turbine generator farm 121 may be coupled to power node 126 with conventional three-phase alternating current power (although other systems may also be used). The conversion equipment within the bi-directional local power node 126 will convert the power from the wind turbine generator farm 121 (three-phase alternating current in this example) to add voltage to the loop-based direct current electrical power transmission system thereby providing electrical power to the current loop.

Similarly, power-consuming town 112 is coupled to a bi-directional local power node 117 that is part of the loop-based direct current electrical power transmission system in FIG. 1C. Since the town 112 consumes electrical power, there will be a voltage drop across the associated power node 117. Specifically, the conversion equipment within the bi-directional local power node 117 will convert the electrical power from the loop-based direct current electrical power transmission system into local three-phase alternating current power that can be consumed.

A key feature of the disclosed system is that each node of the loop-based direct current electrical power transmission system only needs conversion equipment that is large enough to handle the amount of voltage that the local node will be adding to or consuming from the transmission system. Thus, instead of requiring conversion equipment that can handle then entire conversion of one million volts, the local conversion equipment can be limited. Specifically, with the disclosed system each node only has to isolate with a transformer the full voltage (which is much less expensive) and only has to withstand the amount of voltage added or removed. For example with local node that only can add/remove 2% of the total energy of 1 million volt system only has to have 20 kilovolt semiconductor stacks that are basically 1/50th the cost of 1 million volt semiconductor stacks.

To operate the system, each node on the current loop network may sense the current of the loop and then add or remove voltage in order to meet the local power input or output requirement. Furthermore, there should also be at least one node on the current loop that can maintain current in the loop. This should be done since the total energy into and out of the system must be balanced. Thus, there will generally need to be either grid ties that adjust, generation systems that adjust, or load banks that adjust to maintain the balance. For example, conventional power generation plant 123 may be tasked with adjusting the system as required. Power generation plant 123 may add additional voltage as required and may have a load to consume extra power when required.

FIG. 2 illustrates a block diagram of one embodiment of a bi-directional power node 200 that may be used within the loop-based direct current electrical power transmission system illustrated in FIG. 1C. On the left side of FIG. 2 the bi-directional power node 200 is coupled to the local three-phase alternating current distribution network 280. On the right side of FIG. 2 the bi-directional power node 200 is coupled to the loop-based direct current electrical power transmission system of FIG. 1C with a current loop input 251 and a current loop output 252.

For a site with electrical power generation capacity, the local three-phase alternating current may first be converted to direct current with a bi-directional three-phase alternating current to direct current converter 210. In one embodiment, the bi-directional three-phase alternating current to direct current converter 210 converts the electricity to around a 10 kilovolt direct current level. The technology for such an alternating current to direct current conversion is well-known in the art.

The direct current from converter 210 is then changed into high-frequency alternating current with a bi-directional direct current to high-frequency alternating current converter 220. By converting to high-frequency alternating current, the costs of transformers can be minimized. Typically, the higher the alternating current frequency the smaller the transformer can be. In one embodiment, the high-frequency alternating current may be implemented with square-wave alternating current.

An isolating transformer 225 can then be used to couple the next two stages. The isolating transformer 225 electrically isolates the local three-phase alternating current distribution network 280 from the direct current loop network that couples together all of the power generating and consuming sites. The electrical isolation helps prevent any problems on a local three-phase alternating current distribution network from affecting the loop-based direct current electrical power transmission system.

After the isolation transformer 225, a bi-directional high-frequency alternating current to direct current converter 230 converts the high-frequency alternating current into direct current on the direct current loop. Thus, for a site with electric generation site, energy from the local three-phase alternating current distribution network 280 is transferred into energy onto the direct current loop. That energy placed onto the direct current loop can be consumed by other sites coupled to the direct current loop.

Unlike traditional electrical power transmission systems wherein the voltage is held nominally constant while additional current is added to add more energy, with the loop-based direct current electrical power transmission system of this disclosure the current within the current loop is held nominally constant and the voltage across the local node 200 changes depending upon the amount of energy being added to subtracted. Specifically, the amount of voltage potential from the current loop in 251 to the current loop out 252 will depend on the amount of energy being input from the local three-phase alternating current distribution network 280.

For example, if a large amount of power is generated on the local distribution network 280 then there will be a large voltage increase from the current loop in 251 to the current loop out 252. If no electrical power is generated on the local distribution network 280 then there will be no voltage change from the current loop in 251 to the current loop out 252. When power is consumed on the local distribution network 280 then there will be a voltage drop from the current loop in 251 to the current loop out 252.

FIG. 3 illustrates an alternative implementation of a local current loop node 300. In the current loop node 300 of FIG. 3, the electrical power from the local three-phase alternating current distribution network 380 is immediately converted to high-frequency alternating current with a bi-directional three-phase alternating current to high-frequency alternating current converter 310.

The high-frequency alternating current is then passed through isolating transformer 325 to isolate the local three-phase alternating current distribution network 380. Then the high-frequency alternating current is converted to direct current for the current loop with a bi-directional high-frequency alternating current to direct current converter 330.

The implementation of a power node in FIG. 3 has less components that the implementation of a power node FIG. 2. However, the implementation of FIG. 3 may end up being ultimately more expensive to correct. The difficulty lies within the bi-directional three-phase alternating current to high-frequency alternating current converter 310 which may be very expensive to construct. Specifically, a one megavolt three-phase alternating current to high-frequency converter would likely use a 60 cycle three-phase transformer instead of high-frequency transformer such that the transformer would be very expensive.

In yet another alternate version, the isolation transformer may be a 60 cycle three-phase transformer. Then the isolated 60 cycle three-phase power can be directly converted to direct current for the current loop. Such a system minimizes the transitions but, like the system of FIG. 2, may require expensive equipment to the 60 cycle three-phase isolation transformer.

A key feature to the loop-based direct current network is that even though it operates with a nominally constant current loop, the system is bi-directional from every individual node. For example, FIG. 1D illustrates the direct current electrical power transmission network of FIG. 1C wherein town 113 has added their own local wind turbine farm 133. On windy days, the local wind turbine farm 133 may produce more electrical power than town 113 requires such that town 113 can add power to the loop-based direct current electrical power transmission network. Conversely, on calm days town 113 will need to draw power from the loop-based direct current electrical power transmission network. With the bi-directional power node 118 as implemented in FIGS. 2 and 3, either situation can be easily handled.

Note that in addition to the electrical transmission lines that couple the local power nodes (116, 117, 118, 120, 126, 127, 128, and 129), the power nodes are also coupled by communication lines that allow the local power nodes to cooperate with each other in order to maintain the balance of the system. Thus, for example, each individual node may be able to signal when that node will be consuming or generating more power. Similarly, anticipated changes can also be shared in order to plan for changes.

Communication can also be used to help cooperatively adjust the system in view of current conditions. For example, the nominal constant current flowing through the loop-based direct current electrical power transmission network may be raised during the day-time to handle the larger day time power requirements. Then, the current in the system may be lowered at night-time when there is lower power demand. Reducing the amount of current during periods of low demand can reduce the overall transmission losses of the system.

To improve the robustness of the system, more than one conductor may be used to couple the various power nodes. FIG. 1E illustrates an embodiment wherein there are two different direct current loops, a clockwise direct current loop and a counter-clockwise direct current loop. In such an embodiment, if one of the transmission lines is severed then the other transmission line can be used to continue operation of the loop-based direct current electrical power transmission network system.

The preceding technical disclosure is intended to be illustrative, and not restrictive. For example, the above-described embodiments (or one or more aspects thereof) may be used in combination with each other. Other embodiments will be apparent to those of skill in the art upon reviewing the above description. The scope of the claims should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract is provided to comply with 37 C.F.R. §1.72(b), which requires that it allow the reader to quickly ascertain the nature of the technical disclosure. The abstract is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

What is claimed is:

1. An electrical power distribution system, said electrical power distribution system comprising:
a first direct current transmission network, said first direct current transmission network carrying direct current in a first current loop; and
a plurality of bi-directional power nodes on said first direct current transmission network, each of said bi-directional power nodes comprising a bi-directional alternating current to direct current conversion system.

2. The electrical power distribution system as set forth in claim 1 wherein said bi-directional alternating current to direct current converter comprises:
a bi-directional three-phase alternating current to direct current converter;
a bi-directional direct current to high-frequency alternating current converter; and
a bi-directional high-frequency alternating current to direct current converter.

3. The electrical power distribution system as set forth in claim 1 wherein said bi-directional alternating current to direct current converter comprises:
a bi-directional three-phase alternating current to high-frequency alternating current converter; and
a bi-directional high-frequency alternating current to direct current converter.

4. The electrical power distribution system as set forth in claim 1 wherein said electrical power distribution system further comprises:
a second direct current transmission network, said second direct current transmission network carrying direct current in a second current loop in opposite direction of said first current loop.

5. The electrical power distribution system as set forth in claim 1 wherein said electrical power distribution system further comprises:
a communication network, said communication network coupling said plurality of bi-directional power nodes.

6. The electrical power distribution system as set forth in claim 1 wherein said bi-directional alternating current to direct current conversion system converts from three-phase alternating current to a voltage difference on said direct current loop.

7. A method of transmitting electrical power, said method of transmitting electrical power comprising:
coupling together a plurality of bi-directional power nodes with a plurality of transmission lines to form a current loop transmission network; and
adding voltage to said current loop transmission network at bi-directional power nodes hosting power generation equipment; and
subtracting voltage from said current loop transmission network at bi-directional power nodes hosting power consumers equipment.

8. The method of transmitting electrical power as set forth in claim 7 wherein subtracting voltage from said current loop transmission network comprises:
converting voltage on said direct current loop transmission network to a high-frequency alternating current;
converting said high-frequency alternating current to a direct current; and
converting said direct current to a three-phase alternating current.

9. The method of transmitting electrical power as set forth in claim 8 wherein said three-phase alternating current drives a local distribution network.

10. The method of transmitting electrical power as set forth in claim 7 wherein adding voltage to said current loop transmission network comprises:
converting a three-phase alternating current to direct current;
converting said direct current to a high-frequency alternating current; and
converting said high-frequency alternating current to increased voltage on said direct current loop transmission network.

11. The method of transmitting electrical power as set forth in claim 7 wherein subtracting voltage from said current loop transmission network comprises:
converting voltage on said direct current loop transmission network to a high-frequency alternating current;
converting said high-frequency alternating current to a three-phase alternating current.

12. The method of transmitting electrical power as set forth in claim 11 wherein said three-phase alternating current drives a local distribution network.

13. The method of transmitting electrical power as set forth in claim 7 wherein adding voltage to said current loop transmission network comprises:
converting a three-phase alternating current to a high-frequency alternating current; and
converting said high-frequency alternating current to increased voltage on said direct current loop transmission network.

14. The method of transmitting electrical power as set forth in claim 7 wherein said method of transmitting electrical power further comprises:
coupling together said plurality of bi-directional power nodes with a communication network.
